(19) United States
(12) Patent Application Publication
(10) Pub. No.: US 2011/0084933 A1
(43) Pub. Date: Apr. 14, 2011

(54) LAMINATED PRINTED CIRCUIT BOARD INDUCTIVE TOUCH SENSOR

(75) Inventors: Keith Curtis, Gilbert, AZ (US); Stephen Porter, Gilbert, AZ (US); John Charais, Phoenix, AZ (US); Mark Loper, Chandler, AZ (US)

(73) Assignee: Microchip Technology Incorporated

(21) Appl. No.: 12/851,732

(22) Filed: Aug. 6, 2010

Related U.S. Application Data
(60) Provisional application No. 61/249,816, filed on Oct. 8, 2009.

(51) Int. Cl. G06F 3/045

(52) U.S. Cl. 345/174

(57) ABSTRACT

A multilayer printed circuit board provides both physical and electrical attributes necessary for creating an inductive touch sensor panel. Inductive sense coils are formed on a surface of first layer of the multilayer printed circuit board. A second layer is used as a spacer between the first layer and a third layer. The first, second and third layers of the multilayer printed circuit board form chambers in which the inductive sense coils are disposed therein. When a force is applied to a portion of the third layer proximate to an inductive sense coil, a metal target on a face of the third layer is biased toward the inductive sense coil and thereby changes the inductance value thereof.

### RELATED PATENT APPLICATION

This application claims priority to commonly owned U.S. Provisional Patent Application Ser. No. 61/249,816; filed Oct. 8, 2009; entitled “Laminated Printed Circuit Board Inductive Sensor,” by Keith Curtis, Stephen Porter and John Charais; and is hereby incorporated by reference herein for all purposes.

### TECHNICAL FIELD

The present disclosure relates to inductive touch sensors, and more particularly, to a laminated printed circuit board inductive touch sensor.

### BACKGROUND

Inductive touch sensor technology may be used as an alternative to capacitive touch sensor technology. An inductive touch sensor comprises a target (surface being touched or pressed), a spacer and an inductance coil. When the target is actuated (e.g., touched) the coil inductance changes value. Detection of this change in the inductance value of the coil indicates actuation of the inductive touch sensor. Manufacture of an inductive touch panel, comprising a plurality of inductive touch sensors, requires assembly of a sensor sandwich on a printed circuit board (PCB), generally at final assembly of a product. The spacer must be placed between the PCB which contains the inductance coils, one for each key or button, and the targets for each key or button. Current manufacturing technologies consist of producing the PCB, the spacer, laminating the spacer to the PCB and then mounting the PCB/Spacer assembly to the target panel.

The spacer which is required for inductive touch system needs to be made from an insulating material which will not compress when the target is pressed. Currently all designs today consist of a spacer that is made independently of the PCB. This causes additional process steps where the spacer, and inductance coils on the PCB are manufactured separately then in another step laminated together.

### SUMMARY

What is needed is a simplified way to manufacture an inductive touch system. According to the teachings of this disclosure, a spacer may be designed directly onto a printed circuit board (PCB) to eliminate having to manufacture the spacer and PCB separately then having to laminate the spacer onto the PCB. This results in a significant simplification of the manufacture of an inductive touch system by eliminating the assembly of the sensor sandwich at final assembly. By building the stack as part of the PCB means that this assembly can be pre-built, allowing, for example but not limited to, a simple peel and stick operation at final assembly.

PCBs are made by using multiple layers of an insulating material having conductors laminated to their surfaces. As the PCBs become more complicated, more layers are required. Some of the insulating materials used by the PCB manufacturers have the same characteristics that are required by the spacer of an inductive touch sensor, e.g., substantially incompressible. Integrating the spacer with the PCB during design thereof, from a PCB manufacturing standpoint, results in minimal additional work since the spacer can now be considered as just an additional PCB layer(s).

The material required for the spacer must be non-conductive and non-compressing. Therefore, only some of the insulating materials used in PCB manufacturing meet this criteria. Also the geometries required for the spacer are not typical for a PCB. For example, a typical drilled hole needed for the spacer to surround an inductance coil is about 1-1.5 inches in diameter, whereas for mounting components onto a PCB the largest hole is typically about ⅜ inch or smaller.

PCB's are not often viewed as a physical structure of an application but rather they are designed to fit the electronic circuits into an existing space. The spacer is a critical physical element for an inductive touch sensor system, since without it the inductive touch sensor system would not work. Having the spacer as part of the PCB takes advantage of the physical structure of the PCB for providing economical inductive touch sensors as well as a space for the electronic components associated therewith.

According to a specific example embodiment of this disclosure, an inductive touch sensor multilayer printed circuit board comprises: a first nonconductive layer of a multilayer printed circuit board, the first nonconductive layer having a printed circuit inductor on a first face thereof, printed circuit conductors on a second face thereof, the second face printed circuit conductors adapted for connection to electronic devices, whereby the printed circuit inductor and the electronic devices are electrically connected together; a second nonconductive layer laminated to the first nonconductive layer of the multilayer printed circuit board, the second nonconductive layer having an opening around the printed circuit inductor; and a third layer laminated to the second nonconductive layer of the multilayer printed circuit board, whereby a chamber is formed around the printed circuit inductor by the first and second nonconductive layers and the third layer, the third layer having an inductance value influencing property, wherein when a portion of the third layer located over the chamber is biased toward the printed circuit inductor an inductance value thereof changes.

According to another specific example embodiment of this disclosure, an inductive touch sensor panel multilayer printed circuit board comprises: a first nonconductive layer of a multilayer printed circuit board, the first nonconductive layer having a plurality of printed circuit inductors on a first face thereof, printed circuit conductors on a second face thereof, the second face printed circuit conductors adapted for connection to electronic devices, whereby the plurality of printed circuit inductors and the electronic devices are electrically connected together; a second nonconductive layer laminated to the first nonconductive layer of the multilayer printed circuit board, the second nonconductive layer having openings around each of the plurality of printed circuit inductors; and a third layer laminated to the second nonconductive layer of the multilayer printed circuit board, whereby chambers are formed around each of the plurality of printed circuit inductors by the first and second nonconductive layers and the third layer, the third layer having an inductance value influencing property, wherein when a portion of the third layer located over a one of the chambers is biased toward a respective one of the plurality of printed circuit inductors an inductance value thereof changes.

### BRIEF DESCRIPTION OF THE DRAWINGS

A more complete understanding of the present disclosure thereof may be acquired by referring to the following description taken in conjunction with the accompanying drawings wherein:

FIG. 1 is a schematic block diagram of an electronic system having an inductive touch keypad, an inductive touch analog front end and a digital processor, according to the teachings of this disclosure;

FIG. 2 is a schematic frontal view of the inductive touch keypad of FIG. 1 showing an inductive sense coil that is typical for all keys of the keypad;

FIG. 3 is a schematic cutaway view of an inductive touch key formed with a multilayer printed circuit board, according to a specific example embodiment of this disclosure;

FIG. 4 is a schematic cutaway view of the inductive touch key shown in FIG. 3 being actuated by an external force, according to the teachings of this disclosure; and

FIG. 5 is a schematic elevational view of a portion of the printed circuit board comprising an inductive touch sensor, according to a specific example embodiment for one of the touch keys shown in FIGS. 2 and 3.

While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims.

### DETAILED DESCRIPTION

Referring now to the drawings, the details of an example embodiment is schematically illustrated. Like elements in the drawings will be represented by like numbers, and similar elements will be represented by like numbers with a different lower case letter suffix.

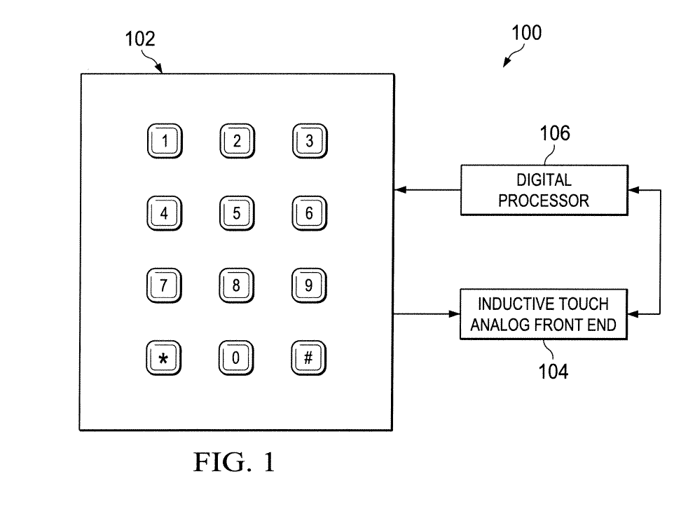

Referring to FIG. 1, depicted is a schematic block diagram of an electronic system having an inductive touch keypad, an inductive touch analog front end and a digital processor, according to the teachings of this disclosure. A digital processor 106, e.g., a microprocessor, microcomputer, digital signal processor (DSP), application specific integrated circuit (ASIC), programmable logic array (PLA), etc., is coupled to an inductive touch analog front end (AFE) 104 and a matrix of inductive touch sensor keys 102, e.g., pushbuttons, targets, etc. The digital processor 106 and AFE 104 may be part of a mixed signal (analog and digital circuits) integrated circuit device.

The inductive touch AFE 104 facilitates, with a single low-cost integrated circuit device, all active functions used in determining when there is actuation of inductive sensors, e.g., by pressing and deflecting a target key that changes the inductance value of an associated inductive sensor. The inductive touch AFE 104 measures the inductance value of each sensor of the matrix of inductive touch sensor keys 102 and converts the inductance values into respective analog direct current (dc) voltages that are read and converted into digital values by the digital processor 106.

The digital processor 106 supplies clock and control functions to the inductive touch AFE 104, reads the analog voltage detector output of the inductive touch AFE 104, and selects each key of the matrix of inductive touch sensor keys 102. When actuation of a key of the matrix of inductive touch sensor keys 102 is determined, the digital processor 106 will take an appropriate action.

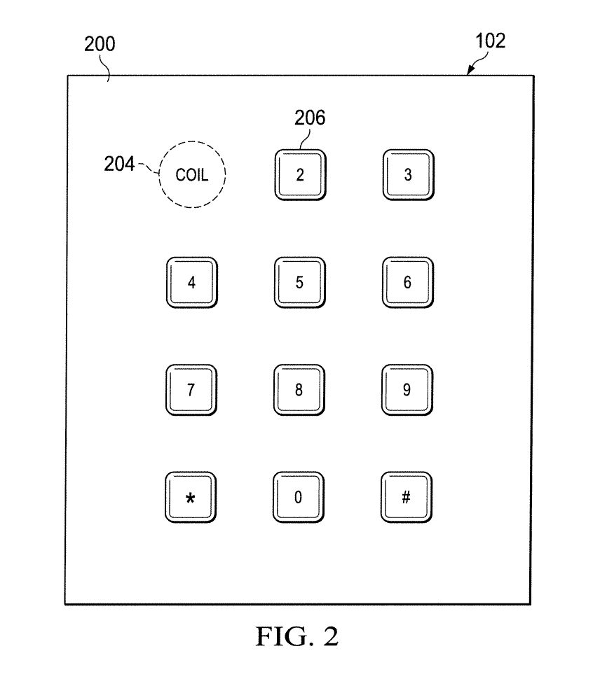

Referring to FIG. 2, depicted is a schematic frontal view of the inductive touch keypad of FIG. 1 showing an inductive sense coil that is typical for all keys of the keypad. The keypad 200 of the matrix of inductive touch sensor keys 102 comprises a plurality of inductive touch sensors 206. In each one of the plurality of inductive touch sensors 206 is a coil 204 having an inductance value that changes when an inductance affecting material, e.g., metal, changes position in relation to the coil 204, as more fully described hereinafter.

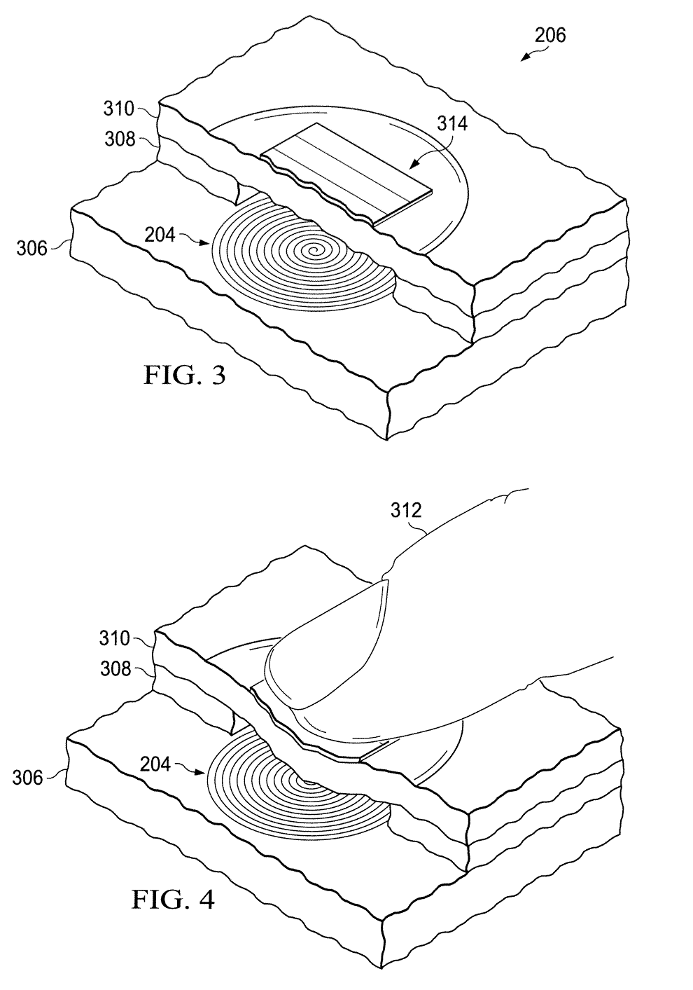

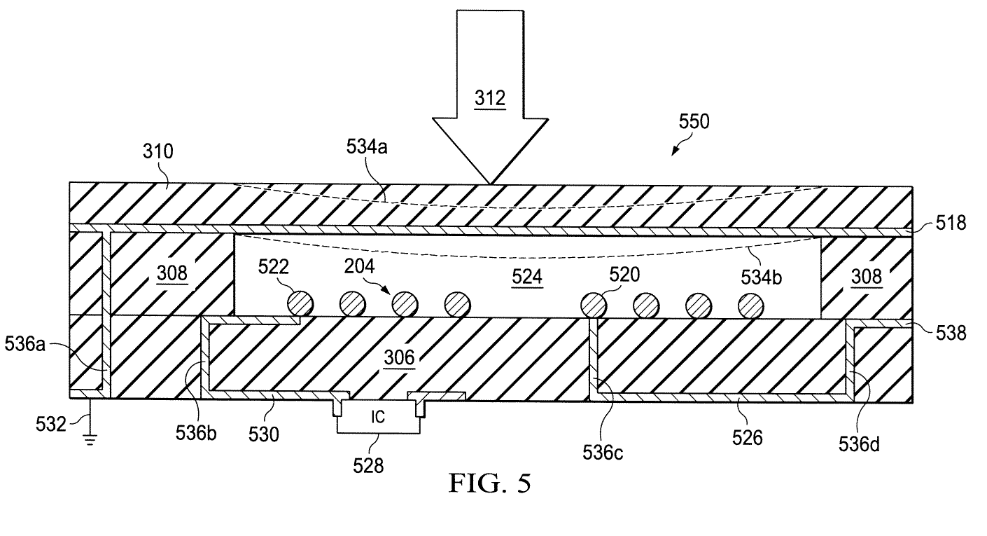

FIG. 3 is a schematic cutaway view of an inductive touch key formed with a multilayer printed circuit board, according to a specific example embodiment of this disclosure. The plurality of inductive touch sensors 206 may be fabricated from a single multilayer printed circuit board that also may be used to interconnect electronic components, e.g., the digital processor 106 and AFE 104 to each of the plurality of inductive touch sensors 206 (see FIG. 5). The coil 204 is formed on a first printed circuit board layer 306. A second printed circuit board layer 308 having an opening for each of the coils 204 is used as a spacer. A third printed circuit board layer 310 covers the second printed circuit board layer 308 and the openings around each of the coils 204. The second printed circuit board layer 308 is substantially non-deformable. The third printed circuit board layer 310 is deformable at each of the openings over the coils 204. A legend 314 may be placed on an front surface area of the third printed circuit board layer 310 for each of key of the matrix of inductive touch sensor keys 102 (FIG. 2) for indicating the purpose or function of that key, e.g., 1, 2, 3, 4, start, stop, dry, warm, toast, etc.

FIG. 4 is a schematic cutaway view of the inductive touch key shown in FIG. 3 being actuated by an external force, according to the teachings of this disclosure. When a force 312, e.g., a finger, presses on a portion of the third printed circuit board layer 310 located over a coil 204, that portion of the third printed circuit board layer 310 moves toward the coil 204. Since the second printed circuit board layer 308 is substantially non-deformable, only the coil 204 having the force 312 to the third printed circuit board layer 310 applied directly over that the coil 204 will have a change in inductance value. The other coils 204 of the plurality of inductive touch sensors 206 will not be affected.

FIG. 5 is a schematic elevational view of a portion of the printed circuit board comprising an inductive touch sensor, according to a specific example embodiment for one of the touch keys shown in FIGS. 2 and 3. Each of the plurality of inductive touch sensors 206 (FIG. 2) is fabricated in a single multi-layer printed circuit board, generally represented by the numeral 550, and comprises the first printed circuit board layer 306, second printed circuit board layer 308 and third printed circuit board layer 310. One or more of the printed circuit board layers 306, 308 and/or 310 may have conductive foil arranged in patterns or as a solid conductive surface(s) on one or both sides thereof. In addition, interconnections between these conductive foils of the printed circuit board layers may be accomplished with plated through hole vias 536 as is well known to one skilled in the art of printed circuit board fabrication and having the benefit of this disclosure.

The coil 204 may be formed in the conductive foil on an inside face of the first printed circuit board layer 306. The beginning 520 and end 522 of the coil 204 conductive foil is connected to other circuits through vias 536b and 536c, and conducts 530, 526 and 538. Electronic components 528, e.g., digital processor 106 and AFE 104 in an integrated circuit package(s) may be attached mechanically and electrically to foil patterns 530 on a face of the first printed circuit board layer 306 by, e.g., surface mount soldering.

A chamber 524 is formed by the intersections of the first printed circuit board layer 306, the second printed circuit board layer 308, and the third printed circuit board layer 310. Within this chamber 524, a portion of the third printed circuit board layer 310 defects toward the coil 204 when the force 312 is applied thereto.

A conductive surface 518 on a face of the third printed circuit board layer 310 proximate to the coil 204 may be used as a target that influences the inductance value of the coil 204. When the third printed circuit board layer 310 is biased toward the coil 204 (e.g., displacement 534) by force 312 being applied to a portion thereof, the inductance value of the coil 204 will change. This change in inductance value is detected by the AFE 104. The conductive surface 518 may be grounded through plated through hole via 536a. Similarly, the coil 204 may be electrically connected to the electronic components 528 with vias 536b and 536c, and conducts 530, 526 and 538.

A metal fascia may be used in place of the third printed circuit board layer 310 and conductive surface 518, and may be fabricated with the other printed circuit board layers 306 and 308 during manufacture of the printed circuit board comprising the matrix of inductive touch sensor keys 102. It is contemplated and within the scope of this disclosure that more than two or three printed circuit board layers may be used as required by the application design.

Many different materials may be used for the first, second and third layers so long as the physical and electrical properties required herein are met. One having ordinary skill in the art of multilayer printed circuit board fabrication would know what materials would be appropriate by having knowledge of this disclosure. Some dielectrics that may be used, but not limited to, are as follows: polytetrafluoroethylene (Teflon), FR-4, FR-1, CEM-1 or CEM-3. In addition, well known prepreg materials used in the PCB industry are FR-2 (phenolic cotton paper), FR-3 (cotton paper and epoxy), FR-4 (woven glass and epoxy), FR-5 (woven glass and epoxy), FR-6 (matte glass and polyester), G-10 (woven glass and epoxy), CEM-1 (cotton paper and epoxy), CEM-2 (cotton paper and epoxy), CEM-3 (woven glass and epoxy), CEM-4 (woven glass and epoxy), and CEM-5 (woven glass and polyester).

While embodiments of this disclosure have been depicted, described, and are defined by reference to example embodiments of the disclosure, such references do not imply a limitation on the disclosure, and no such limitation is to be inferred. The subject matter disclosed is capable of considerable modification, alteration, and equivalents in form and function, as will occur to those ordinarily skilled in the pertinent art and having the benefit of this disclosure. The depicted and described embodiments of this disclosure are examples only, and are not exhaustive of the scope of the disclosure.

What is claimed is:

1. An inductive touch sensor multilayer printed circuit board, comprising:
a first nonconductive layer of a multilayer printed circuit board, the first nonconductive layer having a printed circuit inductor on a first face thereof, printed circuit conductors on a second face thereof, the second face printed circuit conductors adapted for connection to electronic devices, whereby the printed circuit inductor and the electronic devices are electrically connected together;
a second nonconductive layer laminated to the first nonconductive layer of the multilayer printed circuit board, the second nonconductive layer having an opening around the printed circuit inductor; and
a third layer laminated to the second nonconductive layer of the multilayer printed circuit board, whereby a chamber is formed around the printed circuit inductor by the first and second nonconductive layers and the third layer, the third layer having an inductance value influencing property, wherein when a portion of the third layer located over the chamber is biased toward the printed circuit inductor an inductance value thereof changes.

2. The inductive touch sensor according to claim 1, wherein the inductance value influencing property of the third layer is a metal foil on a face of a nonconductive third layer proximate to the printed circuit inductor.

3. The inductive touch sensor according to claim 2, wherein the metal foil of the third layer is connected to a circuit common through at least one conductive via running from the third layer, through the second layer and to the first layer of the multilayer printed circuit board.

4. The inductive touch sensor according to claim 3, wherein the circuit common is a circuit ground.

5. The inductive touch sensor according to claim 1, wherein the third layer comprises a metal that influences the inductance value of the printed circuit inductor.

6. The inductive touch sensor according to claim 5, wherein the metal third layer is connected to a circuit common through at least one conductive via running from the metal third layer, through the second layer and to the first layer of the multilayer printed circuit board.

7. The inductive touch sensor according to claim 1, further comprising a legend on an external surface of the third layer of the multilayer printed circuit board.

8. The inductive touch sensor according to claim 1, wherein material for the first and second nonconductive layers is selected from the group consisting of polytetrafluoroethylene (Teflon), FR-4, FR-1, CEM-1 or CEM-3, FR-2 (phenolic cotton paper), FR-3 (cotton paper and epoxy), FR-4 (woven glass and epoxy), FR-5 (woven glass and epoxy), FR-6 (matte glass and polyester), G-10 (woven glass and epoxy), CEM-1 (cotton paper and epoxy), CEM-2 (cotton paper and epoxy), CEM-3 (woven glass and epoxy), CEM-4 (woven glass and epoxy), and CEM-5 (woven glass and polyester).

9. An inductive touch sensor panel multilayer printed circuit board, comprising:
a first nonconductive layer of a multilayer printed circuit board, the first nonconductive layer having a plurality of printed circuit inductors on a first face thereof, printed circuit conductors on a second face thereof, the second face printed circuit conductors adapted for connection to electronic devices, whereby the plurality of printed circuit inductors and the electronic devices are electrically connected together;
a second nonconductive layer laminated to the first nonconductive layer of the multilayer printed circuit board, the second nonconductive layer having openings around each of the plurality of printed circuit inductors; and
a third layer laminated to the second nonconductive layer of the multilayer printed circuit board, whereby chambers are formed around each of the plurality of printed circuit inductors by the first and second nonconductive layers and the third layer, the third layer having an inductance value influencing property, wherein when a portion of the third layer located over a one of the chambers is biased toward a respective one of the plurality of printed circuit inductors an inductance value thereof changes.

10. The inductive touch sensor panel according to claim 9, wherein the inductance value influencing property of the third layer is a metal foil on a face of a nonconductive third layer proximate to the plurality of printed circuit inductors.

11. The inductive touch sensor panel according to claim 10, wherein the metal foil of the third layer is connected to a circuit common through at least one conductive via running from the third layer, through the second layer and to the first layer of the multilayer printed circuit board.

12. The inductive touch sensor panel according to claim 11, wherein the circuit common is a circuit ground.

13. The inductive touch sensor panel according to claim 9, wherein the third layer comprises a metal that influences the inductance values of the plurality of printed circuit inductors.

14. The inductive touch sensor panel according to claim 13, wherein the metal third layer is connected to a circuit common through at least one conductive via running from the metal third layer, through the second layer and to the first layer of the multilayer printed circuit board.

15. The inductive touch sensor panel according to claim 9, further comprising legends on an external surface of the third layer of the multilayer printed circuit board over each one of the plurality of printed circuit inductors.

16. The inductive touch sensor panel according to claim 9, wherein the plurality of printed circuit inductors are arranged as an N row by M column matrix.

17. The inductive touch sensor panel according to claim 9, further comprising an inductive touch analog front end connected to each of the plurality of printed circuit inductors and a digital processor connected to the inductive touch analog front end.

18. The inductive touch sensor panel according to claim 17, wherein the digital processor is selected from the group consisting of a microprocessor, a microcomputer, a digital signal processor (DSP), an application specific integrated circuit (ASIC), and a programmable logic array (PLA).

19. The inductive touch sensor panel according to claim 17, wherein the inductive touch analog front end and digital processor are fabricated in an integrated circuit device connected to the second face printed circuit conductors.
